(19) United States
(12) Patent Application Publication
(10) Pub. No.: US 2025/0385965 A1
(43) Pub. Date: Dec. 18, 2025

(54) Multi-Functional and Hands-Free Mobile Phone Stand

(71) Applicants: Dawn Matthews, Batesburg, SC (US); Nicole Barfield, Branchville, SC (US)

(72) Inventors: Dawn Matthews, Batesburg, SC (US); Nicole Barfield, Branchville, SC (US)

(21) Appl. No.: 19/225,244

(22) Filed: Jun. 2, 2025

Related U.S. Application Data
(60) Provisional application No. 63/659,378, filed on Jun. 13, 2024.

(51) Int. Cl. H04M 1/04; H02J 7/00

(52) U.S. Cl. CPC H04M 1/04; H02J 7/0044

(57) ABSTRACT

A mobile cell phone stand designed to provide hands-free support for mobile phones is disclosed. The stand features a durable base. The base supports a vertical member extending upwards, with a top arm connecting vertical arms, and includes a protruding element compatible with USB-C, Lightning, or Micro-USB ports, equipped with padding to prevent damage. Some embodiments include a pivoting member for adjustable viewing angles, a pass-through charging port for simultaneous phone support and charging, and anti-slip, weighted bases. Additional features include LEDs for illumination and embedded Bluetooth speakers for audio playback. The stand can be customized with designs resembling various types of feet, adding a unique aesthetic appeal.

### CROSS-REFERENCE TO RELATED APPLICATION

The present application claims priority to, and the benefit of, U.S. Provisional Application No. 63/659,378 which was filed on Jun. 13, 2024, and is incorporated herein by reference in its entirety.

### FIELD OF THE INVENTION

The present invention generally relates to the field of mobile phone accessories. More specifically, the present invention pertains to a versatile and multi-functional cell phone stand designed for hands-free use. The stand includes a durable base, a vertical supporting member, and a protruding element compatible with USB-C, Lightning, or Micro-USB ports. The protruding elements fits snugly into the charging port of the cell phone to keep the cell phone upright. The stand provides a stable and convenient solution for hands-free phone usage, making it ideal for video calls, media consumption, and other tasks, thereby improving user convenience and experience. Accordingly, the present disclosure makes specific reference thereto. Nonetheless, it is to be appreciated that aspects of the present invention are also equally applicable to other like applications, devices, and methods of manufacture.

### BACKGROUND

By way of background, mobile phones have become indispensable tools for communication, information consumption, and entertainment. Users frequently prop up their phones to view the screen during video calls, while reading articles, watching videos, following recipes, and performing various other tasks. Traditionally, this requires placing the phone against an object to keep it upright or holding it in hand.

When a phone is propped against an object, the phone often slips, necessitating frequent repositioning to maintain a clear view of the screen. The instability can be frustrating and counterproductive, especially during activities that require a steady and consistent view of the screen, such as during video calls or watching instructional videos. On the other hand, holding the phone in hand leaves only one hand free for other tasks, reducing efficiency and causing discomfort during prolonged use. Existing phone stands do not provide an upright position of the phone and do not reduce slipping of the phone. Individuals desire a reliable, hands-free solution to keep mobile phones upright and stable without the risk of slipping, while also enabling for hands-free operation.

Therefore, there exists a long-felt need in the art for a reliable and efficient means of supporting mobile phones in an upright position for hands-free usage. There is also a long-felt need in the art for a device that prevents phones from slipping and needing constant repositioning. Additionally, there is a long-felt need in the art for a phone stand that enables users to engage in video calls, watch videos, read articles, and perform other tasks without having to hold the phone in hand. Moreover, there is a long-felt need in the art for a versatile and portable phone stand that can be easily adjusted and customized to suit individual preferences and different phone models (i.e., larger screens or fold open screens). Furthermore, there is a long-felt need in the art for a phone stand that offers additional functionalities such as integrated charging and audio features to enhance the user experience. Finally, there is a long-felt need in the art for a phone stand that is both aesthetically pleasing and functionally superior, providing a stable and convenient hands-free solution for a wide range of activities.

The subject matter disclosed and claimed herein, in one embodiment thereof, comprises a versatile and multi-functional cell phone stand. The stand comprises a durable base configured to rest on a surface, with a vertical supporting member extending upwards from the base. The vertical supporting member includes two vertical arms and a top arm connecting their respective top ends. A protruding element designed to fit into a phone's charging port is integrated into the stand, featuring a male connector compatible with USB-C, Lightning port, or Micro-USB and including a grip or padding to prevent damage to the charging port. In one embodiment, the stand includes a pivoting member that enables the phone to be positioned at various angles. Another embodiment includes a pass-through charging port, enabling simultaneous phone support and charging. Additional features such as anti-slip bases, LEDs for illumination, and an embedded Bluetooth speaker are also incorporated to enhance functionality and user experience.

In this manner, the cell phone stand of the present invention accomplishes all of the foregoing objectives and provides a novel solution for hands-free mobile phone usage. The stand utilizes a durable and stable base. The protruding element fits snugly into the phone's charging port, ensuring stability without causing damage. The pivoting member enables users to adjust the viewing angle, while the pass-through charging port supports and charges the phone simultaneously. The anti-slip bases enhance stability, and the integrated LEDs and Bluetooth speaker add functional and aesthetic value. This invention offers a reliable, convenient, and versatile solution for hands-free phone usage, making it ideal for video calls, media consumption, and other tasks where holding the phone is impractical.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cell phone stand. The cell phone stand comprises a base configured to rest on a surface, a vertical supporting member extending vertically upwards from the base, and a protruding element designed to fit into a phone's charging port, the protruding element being a male connector compatible with USB-C, Lightning port, or Micro-USB and including a grip or padding to prevent damage to the charging port of the phone.

In yet another embodiment, a cell phone stand for supporting a cell phone in an upright position is disclosed. The stand includes a base configured to rest on a surface, the base having a pivoting member pivotally mounted to it. A protruding element is designed to fit into a phone's charging port, the protruding element being a male connector compatible with USB-C, Lightning port, or Micro-USB and includes a grip or padding to prevent damage to the charging port of the phone. The pivoting member is configured to transition between a transverse position and a collapsed position.

In another aspect, a cell phone stand is disclosed. The stand comprises a base configured to rest on a surface, a protruding element designed to fit into a phone's charging port, the protruding element being a male connector compatible with USB-C, Lightning port, or Micro-USB, a pass-through charging port disposed on the base, the pass-through charging port is configured to provide power to the cell phone via the protruding element.

In still another aspect, a cell phone stand is disclosed. The cell phone stand comprises a base configured to rest on a surface, the base having anti-slip properties, a protruding element designed to fit into a phone's charging port, the protruding element is a male connector compatible with USB-C, Lightning port, or Micro-USB and including a grip or padding to prevent damage to the charging port of the phone, one or more LEDs disposed on the stand for illumination, and a Bluetooth speaker embedded in the stand for audio playback.

In another embodiment, the base is weighted to improve stability on different surfaces, and the design of the stand resembles various types of feet including animal feet, alien feet, robotic feet, or humorous feet designs.

In still another embodiment, the vertical supporting member includes a mechanism for adjusting the viewing angle of the phone.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of hands-free cell phone stand of the present invention in accordance with one embodiment of the disclosed structure;

FIG. 2 illustrates a perspective view showing a cell phone supported on the cell phone stand of FIG. 1 in accordance with one embodiment of the present invention;

FIG. 3 illustrates a perspective view of another embodiment of the adjustable and multi-functional cell phone stand of the present invention in accordance with the disclosed structure; and

FIG. 4 illustrates a perspective view of yet another embodiment of the hands-free cell phone stand of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a reliable and efficient means of supporting mobile phones in an upright position for hands-free usage. There is also a long-felt need in the art for a device that prevents phones from slipping and needing constant repositioning. Additionally, there is a long-felt need in the art for a phone stand that enables users to engage in video calls, watch videos, read articles, and perform other tasks without having to hold the phone in hand. Moreover, there is a long-felt need in the art for a versatile and portable phone stand that can be easily adjusted and customized to suit individual preferences and different phone models. Furthermore, there is a long-felt need in the art for a phone stand that offers additional functionalities such as integrated charging and audio features to enhance the user experience. Finally, there is a long-felt need in the art for a phone stand that is both aesthetically pleasing and functionally superior, providing a stable and convenient hands-free solution for a wide range of activities.

The present invention, in one exemplary embodiment, is a cell phone stand for supporting a cell phone in an upright position. The stand includes a base configured to rest on a surface, the base having a pivoting member pivotally mounted to it. A protruding element is designed to fit into a phone's charging port, the protruding element being a male connector compatible with USB-C, Lightning port, or Micro-USB and includes a grip or padding to prevent damage to the charging port of the phone. The pivoting member is configured to transition between a transverse position and a collapsed position.

Reference will now be made in detail to the present preferred embodiments of the invention, examples of which are illustrated in the accompanying drawings. Wherever possible, the same reference numerals are used in the drawings and the description to refer to the same or like parts.

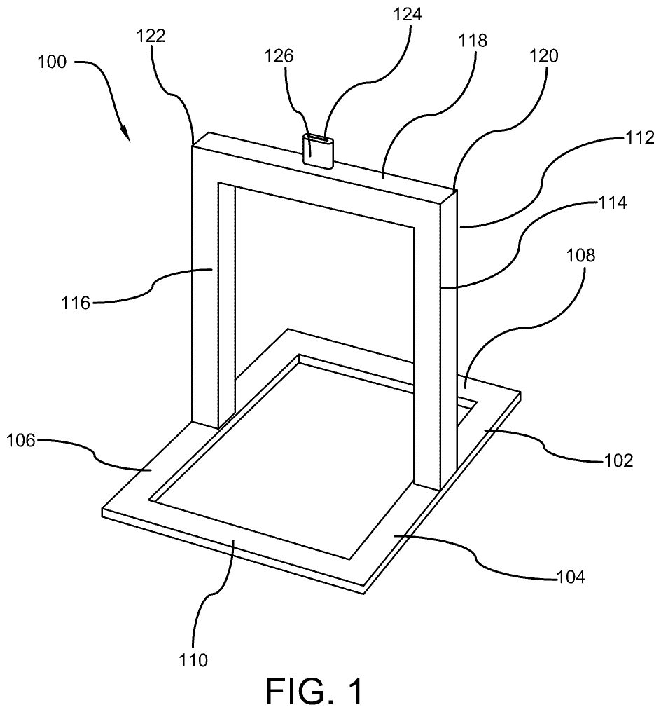

Referring initially to the drawings, FIG. 1 illustrates a perspective view of hands-free cell phone stand of the present invention in accordance with one embodiment of the disclosed structure. The cell phone stand 100 of the present invention is a novel and functional accessory designed to serve as a hands-free stand for mobile phones. More specifically, the cell phone stand 100 is a standalone portable device that can be made from durable materials such as plastic, wood, rubber, or silicone, providing both sturdiness and a good grip on surfaces. The cell phone stand 100 includes a base 102 that is placed on a floor or other supporting surface. The base 102 can be of any geometric shape and provides a substantial surface area for supporting a phone on the cell phone stand 100. In the present embodiment, the base 102 is generally square or rectangular (i.e., rectilinear) and includes two longitudinal arms 104, 106 and two lateral arms 108, 110.

A vertical supporting member 112 extends vertically upwards (i.e., transverse) from the base 102 and preferably extends to provide a uniform distribution of weight on the base 102. The vertical supporting member 112 includes two vertical arms 114, 116 extending transverse from the longitudinal arms 104, 106, respectively, and a top arm 118 connects the top ends 120, 122 of the vertical arms 114, 116. The vertical arms 114, 116 having a height and the longitudinal arms 104, 106 having a length, wherein the height is generally equal to the length. The cell phone stand 100 includes a protruding element 124 which is designed to fit into a phone's charging port. The protruding element 124 is element is preferably a male connector compatible with the phone's charging port such as USB-C, Lightning port, or Micro-USB. The protruding member 124 is adapted to fit snugly into the charging port of the cell phone to ensure stability of the cell phone and does not cause any damage to the port or the phone. The protruding element 124 also includes a grip or padding 126 to further secure the mobile phone and to prevent damage to the charging port of the phone.

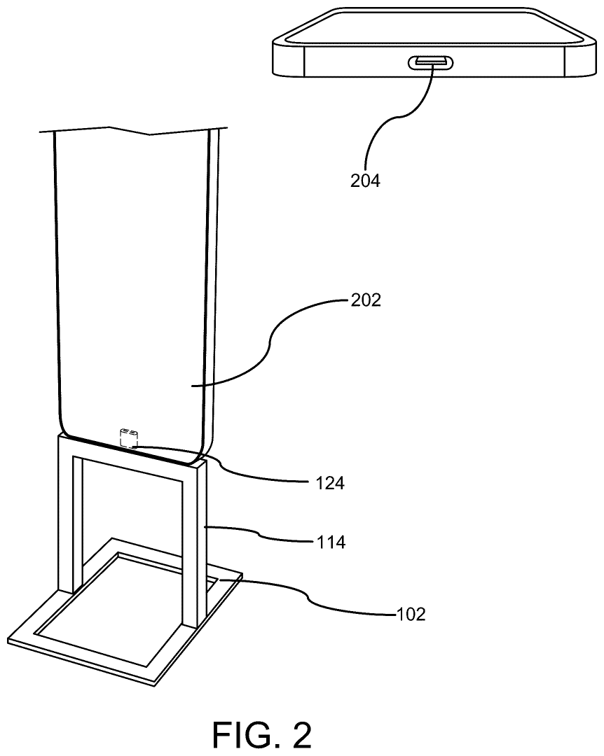

FIG. 2 illustrates a perspective view showing a cell phone supported on the cell phone stand of FIG. 1 in accordance with one embodiment of the present invention. As illustrated, for supporting the cell or mobile phone 202 in an upright position, the protruding element 124 fits snugly into the charging port 204 of the cell or mobile phone 202. Once attached, the stand 100 keeps the mobile phone 202 propped up in an upright position enabling a user to view the phone screen without holding it. The base 102 prevents the phone from tipping over easily. The stand 100 is useful for video calls, enabling users to maintain a steady and consistent camera angle without holding the phone. Users can also comfortably watch videos, browse the web, read articles, or follow recipes hands-free.

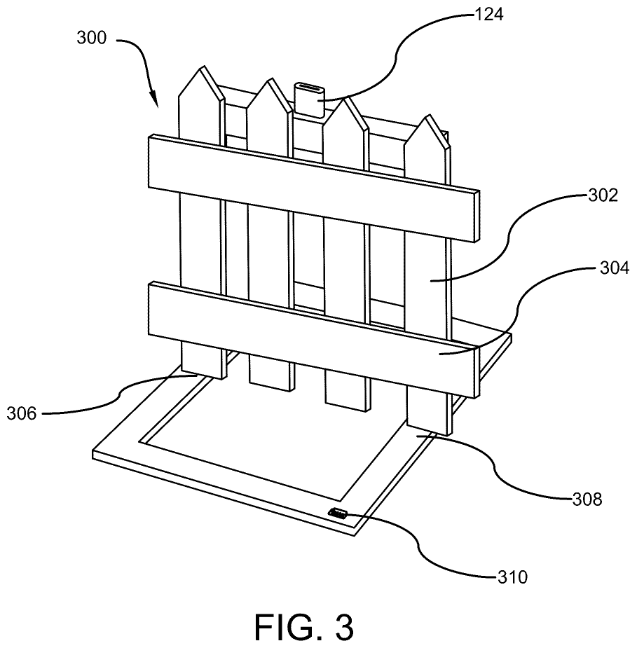

FIG. 3 illustrates a perspective view of another embodiment of the adjustable and multi-functional cell phone stand of the present invention in accordance with the disclosed structure. In the present embodiment, the cell phone stand 300 includes a pivoting member 302 adapted to pivotally mounted to the base 304. The pivoting member 302 is configured to transition between the transverse position as illustrated in FIG. 3 to a collapsed position where the pivoting member 302 pivots and adheres (i.e., collinear) to the base 304. Preferably, the pivoting member 302 includes a pair of hinges 306, 308 for pivoting the pivoting member 302.

The protruding element 124 is disposed and is adapted to fit snugly into the charging port of the cell phone to ensure stability of the cell phone and does not cause any damage to the port or the phone. The pivoting member 302 can be positioned at any appropriate angle relative to the base 304 that enables users to adjust the viewing angle of the phone.

In the present embodiment, a pass-through charging port 310 is disposed on the base 304. When a power supply is provided to the pass-through charging port 310, the protruding element 124 initiates charging of the cell phone engaged to the protruding element 124. In such a scenario, the protruding element 124 performs the dual function of supporting the cell phone in an upright position and charging battery of the cell phone.

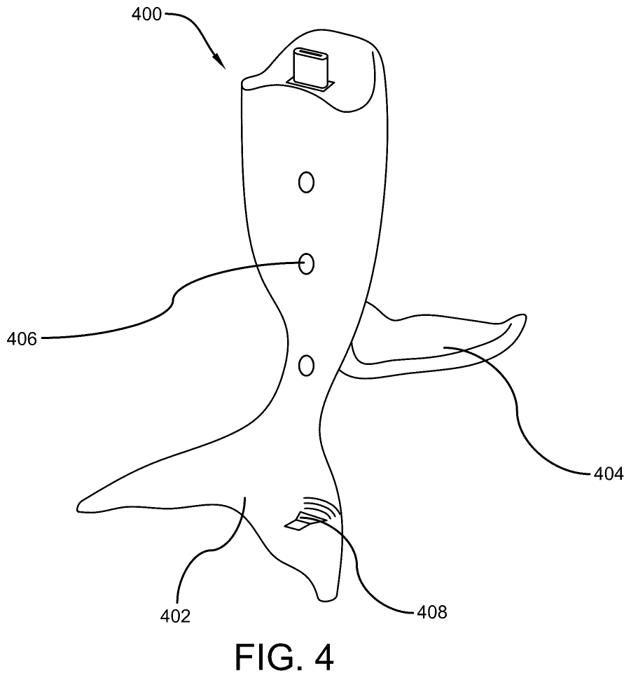

FIG. 4 illustrates a perspective view of yet another embodiment of the hands-free cell phone stand of the present invention in accordance with the disclosed structure. The stand 400 in the present embodiment resembles a mermaid and includes anti-slip bases 402, 404. The bases 402, 404 are weighted to improve stability on different surfaces. One or more LEDs 406 are disposed on the stand 400 for illumination and aesthetics. A Bluetooth speaker 408 is also embedded in the stand 400 for providing playback of audio received from a remote device such as a smartphone.

In use, for supporting a phone, the phone is positioned on the cell phone stand of different embodiments such that the charging port of the phone is positioned on the protruding element. The phone is pushed enabling the protruding element to insert into the charging port of the phone. The protruding element supports the phone in the upright position without requiring a user to hold or support the phone.

The adjustable and multi-functional cell phone stand of different embodiments can be designed to resemble different types of feet like paws, hooves, or claws of various animals, alien feet, robotic feet, or designs like duck feet. The cell phone stand can be customized and made in different colors and designs.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “adjustable and multi-functional cell phone stand”, “hands-free cell phone stand”, “cell phone stand”, and “stand” are interchangeable and refer to the multi-functional and hands-free cell phone stand 100, 300, 400 of the present invention.

Notwithstanding the forgoing, the multi-functional and hands-free cell phone stand 100, 300, 400 of the present invention can be of any suitable size and configuration as is known in the art without affecting the overall concept of the invention, provided that it accomplishes the above stated objectives. One of ordinary skill in the art will appreciate that the multi-functional and hands-free cell phone stand 100, 300, 400 as shown in the FIGS. are for illustrative purposes only, and that many other sizes and shapes of the multi-functional and hands-free cell phone stand 100, 300, 400 are well within the scope of the present disclosure. Although the dimensions of the multi-functional and hands-free cell phone stand 100, 300, 400 are important design parameters for user convenience, the multi-functional and hands-free cell phone stand 100, 300, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hands-free mobile phone stand for holding a mobile phone, the hands-free mobile phone stand comprising:
a portable hands-free stand;
a base having a pair of lateral arms and a pair of longitudinal arms;
a vertical supporting member having a pair of vertical arms; and
a top arm;
wherein said pair of vertical arms extending upward from said pair of longitudinal arms;
wherein said base placeable upon a supporting surface;
wherein said base is rectilinear;
wherein said top arm connecting top ends of said vertical arms; and
further wherein said top arm having a male charging element for connecting to the mobile phone charging port.

2. The hands-free mobile phone stand for holding a mobile phone of claim 1, wherein said male charging element is a male connector selected from the group consisting of a USB-C, a Lightning port, and a Micro-USB.

3. The hands-free mobile phone stand for holding a mobile phone of claim 1, wherein said male charging element having a grip for securing the mobile phone to said top arm in an upright position.

4. The hands-free mobile phone stand for holding a mobile phone of claim 1, wherein said portable hands-free stand having a material selected from the group consisting of a plastic, a wood, a rubber, and a silicone.

5. The hands-free mobile phone stand for holding a mobile phone of claim 1, wherein said pair of vertical arms having a height and said pair of longitudinal arms having a length, and further wherein said height is equal to said length.

6. The hands-free mobile phone stand for holding a mobile phone of claim 5, wherein said pair of vertical arms extending transverse to said pair of longitudinal arms.

7. The hands-free mobile phone stand for holding a mobile phone of claim 5, wherein said vertical supporting member pivotal relative to said base.

8. The hands-free mobile phone stand for holding a mobile phone of claim 7, wherein said vertical supporting member hingedly connected to said base.

9. The hands-free mobile phone stand for holding a mobile phone of claim 7, wherein said vertical supporting member pivotal from a transverse position relative to said base to a horizontal position collinear with said base.

10. The hands-free mobile phone stand for holding a mobile phone of claim 7, wherein said vertical supporting member pivotal from a transverse position relative to said base to a selected angle relative to said base for adjusting a viewing angle of the mobile phone.

11. A hands-free mobile phone stand for holding a mobile phone, the hands-free mobile phone stand comprising:
a portable hands-free stand;
a base having a pair of lateral arms and a pair of longitudinal arms;
a vertical supporting member having a pair of vertical arms; and
a top arm;
wherein said pair of vertical arms extending upward from said pair of longitudinal arms;
wherein said base is rectilinear;
wherein said top arm connecting top ends of said vertical arms;
wherein said base having a pass-through charging port;
wherein said base having a Bluetooth speaker; and
further wherein said top arm having a male charging element for connecting to the mobile phone charging port.

12. The hands-free mobile phone stand for holding a mobile phone of claim 11, wherein said male charging element is a male connector selected from the group consisting of a USB-C, a Lightning port, and a Micro-USB.

13. The hands-free mobile phone stand for holding a mobile phone of claim 11, wherein said male charging element having a grip for securing the mobile phone to said top arm in an upright position.

14. The hands-free mobile phone stand for holding a mobile phone of claim 11, wherein said portable hands-free stand having a material selected from the group consisting of a plastic, a wood, a rubber, and a silicone.

15. The hands-free mobile phone stand for holding a mobile phone of claim 11, wherein said pair of vertical arms having a height and said pair of longitudinal arms having a length, and further wherein said height is equal to said length.

16. The hands-free mobile phone stand for holding a mobile phone of claim 11, wherein said pair of vertical arms extending transverse to said pair of longitudinal arms.

17. The hands-free mobile phone stand for holding a mobile phone of claim 11, wherein said vertical supporting member pivotal relative to said base.

18. The hands-free mobile phone stand for holding a mobile phone of claim 11, wherein said vertical supporting member hingedly connected to said base.

19. The hands-free mobile phone stand for holding a mobile phone of claim 11, wherein said vertical supporting member pivotal from a transverse position relative to said base to a horizontal position collinear with said base.

20. A hands-free mobile phone stand for holding a mobile phone, the hands-free mobile phone stand comprising:
a portable hands-free stand;
a base having a pair of lateral arms and a pair of longitudinal arms;
a vertical supporting member having a pair of vertical arms; and
a top arm;
wherein said pair of vertical arms extending upward from said pair of longitudinal arms;
wherein said top arm connecting top ends of said vertical arms;
wherein said base having a pass-through charging port;
wherein said base having a Bluetooth speaker;
wherein said top arm having a male charging element for connecting to the mobile phone charging port; and
further wherein said vertical supporting member pivotal from a transverse position relative to said base to a selected angle relative to said base for adjusting a viewing angle of the mobile phone.
